(19) United States
(12) Patent Application Publication
(10) Pub. No.: US 2011/0270689 A1
(43) Pub. Date: Nov. 3, 2011

(54) DIGITAL ADVERTISING SYSTEM

(76) Inventors: Steven Klopf, San Francisco, CA (US); John Yu, Palo Alto, CA (US)

(21) Appl. No.: 13/179,424

(22) Filed: Jul. 8, 2011

Related U.S. Application Data
(63) Continuation of application No. 12/973,600, filed on Dec. 20, 2010.
Application No. 12/973,600 is a continuation of application No. 11/439,492, filed on May 22, 2006, now abandoned.
(60) Provisional application No. 60/683,388, filed on May 20, 2005.
(60) Provisional application No. 60/701,615, filed on Jul. 21, 2005.

(51) Int. Cl. G06Q 30/00

(52) U.S. Cl. 705/14.71

(57) ABSTRACT

An exemplary embodiment providing for one or more improvements includes an advertising auction system that has an administration server for managing available advertising space and advertising auctions. One or more publishers list their available advertising space at the administration server and one or advertisers bid on the available advertising space wherein a highest bidder at a close of an auction will have their advertisement placed at the available advertising space made available by the one or more publishers for a period of time.

### CROSS-REFERENCE TO RELATED APPLICATIONS

This application is a continuation of U.S. patent application Ser. No. 12/973,600, filed Dec. 20, 2010, and entitled “DIGITAL ADVERTISING SYSTEM,” which is a continuation of U.S. patent application Ser. No. 11/439,492, filed May 22, 2006, and entitled “DIGITAL ADVERTISING SYSTEM” and claims the benefit of U.S. Provisional Application No. 60/683,388, filed May 20, 2005, and U.S. Provisional Application No. 60/701,615, filed Jul. 21, 2005, all of which are incorporated herein by reference.

### BACKGROUND

Since the advent of large and relatively inexpensive flat-panel displays, their use in public spaces has become ubiquitous. Some examples of where they are typically installed include department stores, health clubs, airport waiting lounges and they have also been scaled to the size of billboards along busy highway corridors. Content for these public displays are sometimes tailored to an environment. For example, a department store may broadcast music videos in their teen clothing department and a health club or airport waiting lounge may be a member of a specialized network that delivers customized content for those settings. In these situations, time may be allotted for advertisements but these proprietary networks typically reach a small number of locations and therefore a small number of potential customers.

In some situations, a broadcast station or cable channel may perhaps be displayed—for example at a health club. Any advertising displayed probably will not reach its target demographic as the gym patrons are there for another purpose and did not select the program for viewing. Additionally, the provider of the display, for example the club owner, is not receiving any benefit from displaying the advertising.

For the digital billboard flat panel, these screens will typically play a set of advertisements over and over or perhaps randomized. The likelihood of those advertisements reaching their target audience is even more remote. It would be quite coincidental for a potential customer to be driving by at the same time an advertisement is displayed that he would be interested in.

In view of the foregoing, it may be useful to provide methods and systems that are capable of tapping into the growing numbers of public flat panel displays such that advertisements can be effectively delivered to a desired demographic at a particular time and/or setting. Additionally, it may be useful for the methods and systems used for the advertisement deployment to be a source of profit for the provider of those method and systems.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

An embodiment by way of a non-limiting example includes an advertising auction system that has an administration server for managing available advertising space and advertising auctions. One or more publishers list their available advertising space at the administration server and one or advertisers bid on the available advertising space wherein a highest bidder at a close of an auction will have their advertisement placed at the available advertising space made available by the one or more publishers for a period of time.

Another example by way of non-limiting example includes a method for a networked advertising auction that provides for accepting one or more listings of available advertising space from one or more publishers, over a network. One or more bids are also accepted, over the network, from one or more advertisers to utilize the available advertising space and an advertisement from a highest bidder of the one or more advertisers is accepted, over the network as well. Also optionally included is sending the advertisement to a publisher of the one or more publishers to be displayed on the available advertising space.

In addition to the exemplary aspects and embodiments described above, further aspects and embodiments will become apparent by reference to the drawings and by study of the following descriptions.

### BRIEF DESCRIPTION OF THE DRAWINGS

Exemplary embodiments are illustrated in the referenced figures of the drawings. It is intended that the embodiments and figures disclosed herein are to be considered illustrative rather than limiting.

FIG. 1 is a block diagram illustrating a system for receiving and delivery of advertising to remote digital displays, in accordance with an exemplary embodiment;

FIG. 2 is a flowchart illustrating a method for an advertiser to interface with the system of FIG. 1, in accordance with an exemplary embodiment;

FIG. 3 is a flowchart illustrating a method for a publisher to interface with the system of FIG. 1, in accordance with an exemplary embodiment;

FIG. 4 is a flowchart illustrating a method for implementing an advertisement auction utilizing the system of FIG. 1, in accordance with an exemplary embodiment;

FIG. 5 is a block diagram of an embodiment of a network, such as the Internet; and

FIG. 6 is a block diagram of an embodiment of a computer that can be used as a client computer system or a server computer system or as a web server system.

### DETAILED DESCRIPTION

Aspects of the claimed embodiments contemplate methods and systems for the delivery of advertising to digital displays located in any sort of public setting where there is a potential for that advertising to reach a desired demographic. Additionally, the advertisements could be displayed on other mediums such as a webpage. Furthermore, owners of the various display mediums could set up their own rules of availability for their systems. An account management interface can be provided that allows advertisers to set up an account. The advertisers would then be enabled to place bids in an auction for various time slots at specific locations. The highest bidder, at the close of the auction, would then have their advertisements displayed at the selected places and times for a given period. Remote servers could then, in turn, be programmed to display the advertisements according to the results of the auctions. Since a server is controlling the displays, the advertisements can therefore be generated to be displayed in various media formats.

In the context of this disclosure, some terms can be used interchangeably. Some examples include “digital display”, “remote display”, “flat panel display”, “flat panel”, “digital billboard” and various combinations thereof generally refer to a large format display in a public space. Typically the displays would be “thin” in comparison to a traditional CRT set but this is not a requirement. Additionally, smaller diameter displays could also be utilized and is usually dependent on the location.

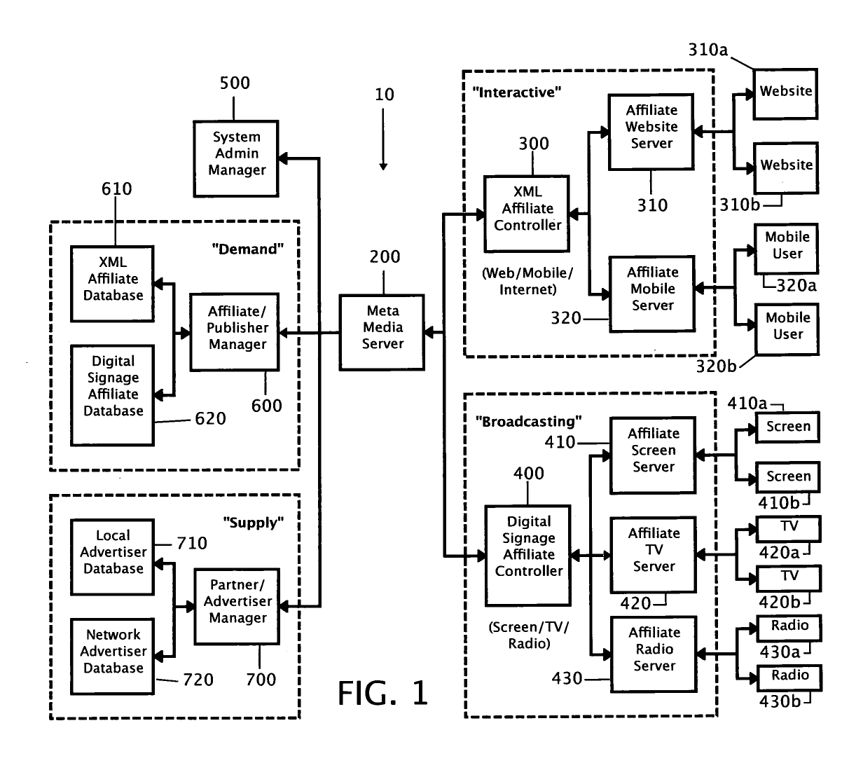

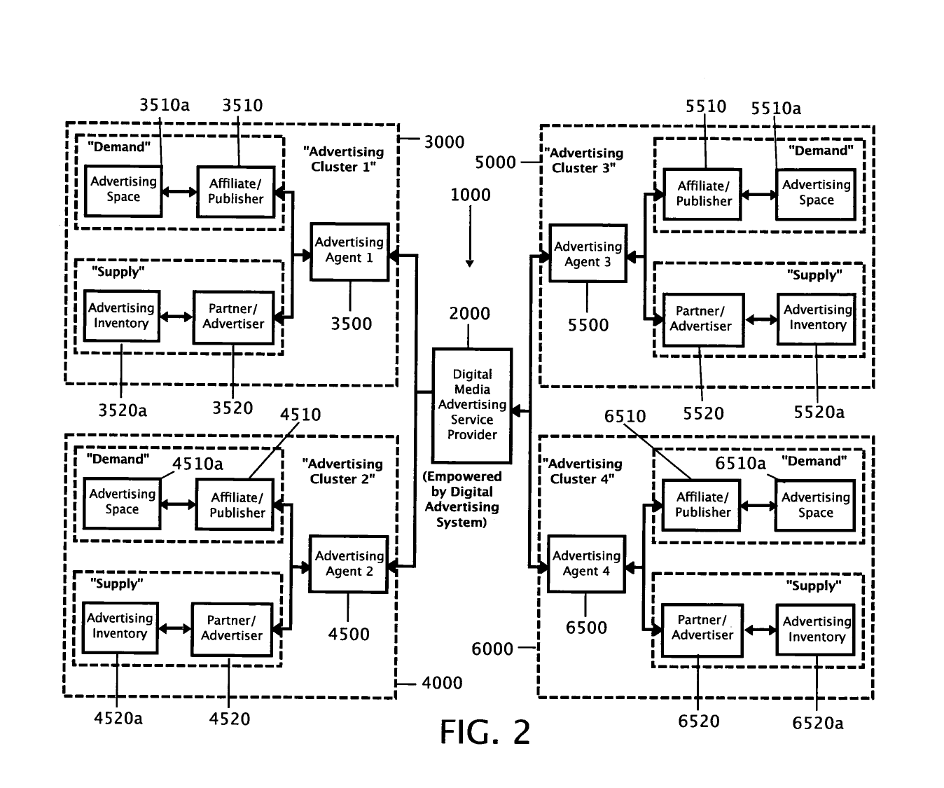

FIG. 1 is a block diagram illustrating a system 10 for receiving and delivery of advertising to remote digital displays, in accordance with an exemplary embodiment. Included in system 10 is a publisher administration center 20 coupled to a website server 30 and a signage server 40. Additionally included in system 10 are text and banner advertisement websites such as those depicted at 50 and 60, an XML affiliate/middleman 70, various advertising agencies and networks 80, digital display players/controllers 90A and 90B and associated digital displays 100A, 100B and 100C. In practice, an advertiser can access the publisher administration center 20 to set up an account and to see what advertising slots are available and where. For example, on websites 50 and 60, on digital displays 100A, 100B and 100C or perhaps on a network 80. The advertiser can then bid on a particular time slot and location and the advertisement will be displayed at the selected place and time if he wins the auction. Typically, the ad will run for a set period of time as defined by the auction. While servers 20, 30 and 40 are shown as separate entities, they could in fact all be running on one server or perhaps two on one server and the other on a separate server.

Optionally, the advertisement could also be required to go through a review process either before or after an auction is won to ensure certain standards are adhered to that could perhaps be dependent on the end display location/medium. As previously alluded to, system 10 can handle any sort of media type and can therefore deliver rich and varied content to remote locations. Also, the owners of the remote website, digital display and actually any sort of end advertising medium such as television, magazine print ads, digital radio, digital audio broadcasts, webcasts and the like can list their mediums on system 10 and advertisers can then bid on the available ad space. The owners would be free to set their pricing models and rules of when the winning advertisements can be displayed.

Digital display controllers/players 90A and 90B can also take the form of a server and do not necessarily need to be permanently coupled to server 40. For example, controllers/players 90A and 90B could merely connect at certain intervals to receive new advertisements and other related updates.

From the advertiser's viewpoint, their advertisements can now be marketed at locations and times they know their targeted demographic would likely see their advertisement and not be constrained by traditional advertising mediums such as print and television. For example, a luxury car maker could bid on ad space via a digital display in a city's financial district during commute times when there is a large probability for high-income financial industry workers to be in abundance. Another example could perhaps embody an athletic shoe manufacturer bidding for displays at health clubs and sports venues. Obviously, the advantages of system 10 could allow advertisers more efficient and focused access to their potential markets. The consumer also benefits as they will be made aware of relevant products. Additionally, an operator/digital publisher of system 10 can be provided with income by collecting a percentage of the winning bids or other means such as charging for medium owners to list their medium availability for advertisers to bid on.

Several embodiments will now be presented to further detail how system 10 can function. FIG. 2 is a flowchart illustrating a method for an advertiser to interface with the system 10 of FIG. 1, in accordance with an exemplary embodiment. After a start operation, a request is received by from an advertiser to manage an account. Typically, this request would be received at publisher administration center 20 and it would be checked to see if the advertiser has an account at decision point 130. If no, an account is created and the account management interface would be presented at operations 140 and 150. If an account already exists, the advertiser would be routed to operation 150 directly. At operation 155, any content the advertiser would like to submit for display will typically go through a content approval process. Operation 155 can be optional. Finally, the advertiser's bids and offers for available ad space can be accepted at operation 160.

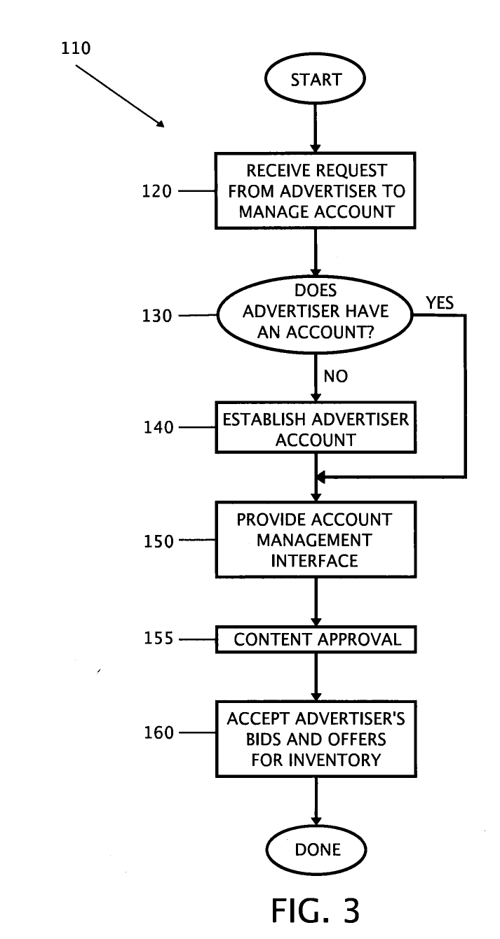

FIG. 3 is a flowchart illustrating a method 170 for a publisher to interface with the system 10 of FIG. 1, in accordance with an exemplary embodiment. In terms of this disclosure, a publisher can be any individual that has a venue available for advertising. Some examples include the previously mentioned digital displays, web pages and Internet portals. Further examples can include magazines, traditional billboards, newspapers and other traditional advertising venues. At an operation 180, a publisher receives a request from a digital publisher to manage a publisher account. At decision point 190, it is determined if the publisher has an account. If no, operation 200 will allow the publisher to establish a new account and the publisher can either exit out of method 170 or continue on with an account management interface at operation 210. If the publisher already has an account, operation 200 is skipped and the account management interface is immediately presented to the publisher at operation 210. At operations 220 and 230, the publisher can define and edit their inventory and also define/edit monetization rules for buying advertising space. Finally, at operation 240, analysis tools are provided to the publisher. The analysis tools, for example, can provide information on bids placed on their inventory and information relating to inventory that has already been purchased.

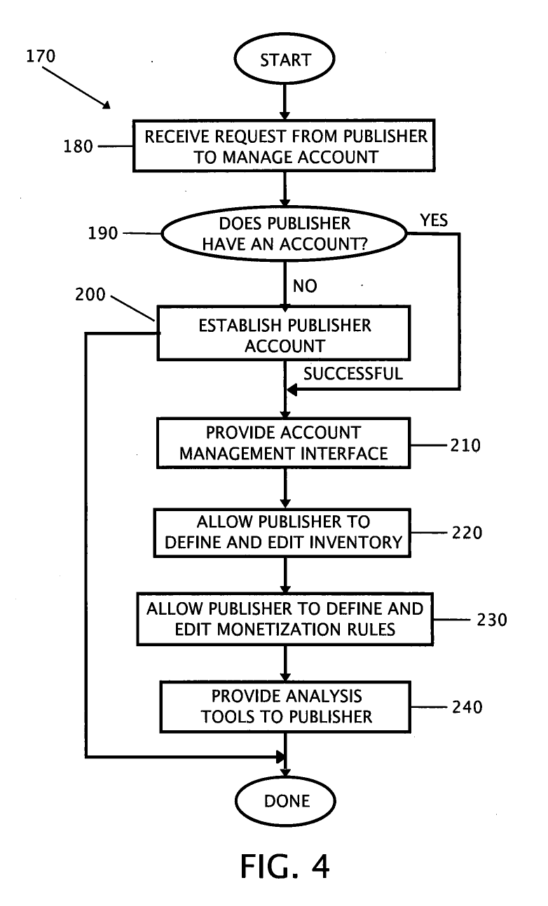

FIG. 4 is a flowchart illustrating a method 250 for implementing an advertisement auction utilizing the system 10 of FIG. 1, in accordance with an exemplary embodiment. At operation 260, a fixed price auction is commenced. At operation 270, rules for the auction are published. The rules can perhaps include a minimum bid, minimum bid relating to the time period the ad could run for, etc. Bidding is then opened and bids can be accepted at operation 280. The auction will continue to run until bidding is closed via decision point 290. Once bidding is closed, the highest bidder's advertisements will be published according to the pre-set rules for the lease period, at operation 300.

While method 250 is primarily geared towards potential advertisers bidding on available ad space, it should be understood that the system can also work the other way around—a “reverse” auction. That is, an advertiser can set up an auction such that he lists rules for his ad—duration, preferred display medium, etc, and publishers would then bid on the chance to display the advertisement. In this scenario, the lowest bid wins and the advertiser pays that lowest bid to the publisher and the advertisement is run for the lease period.

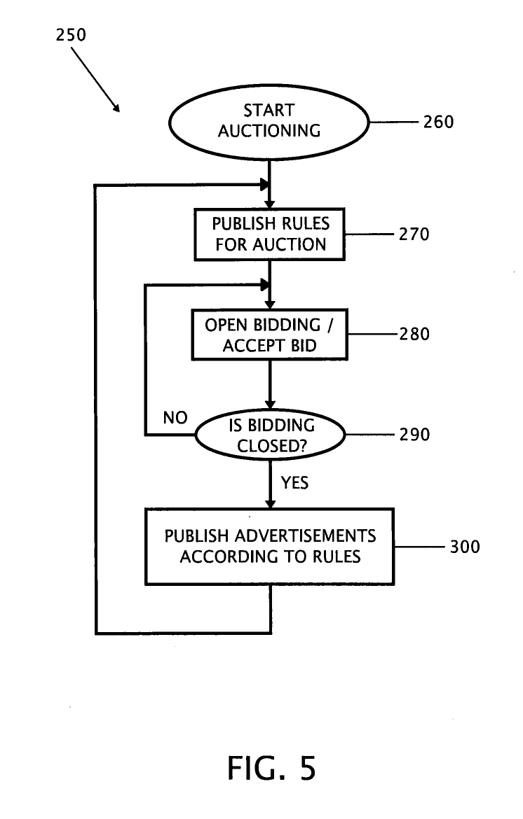

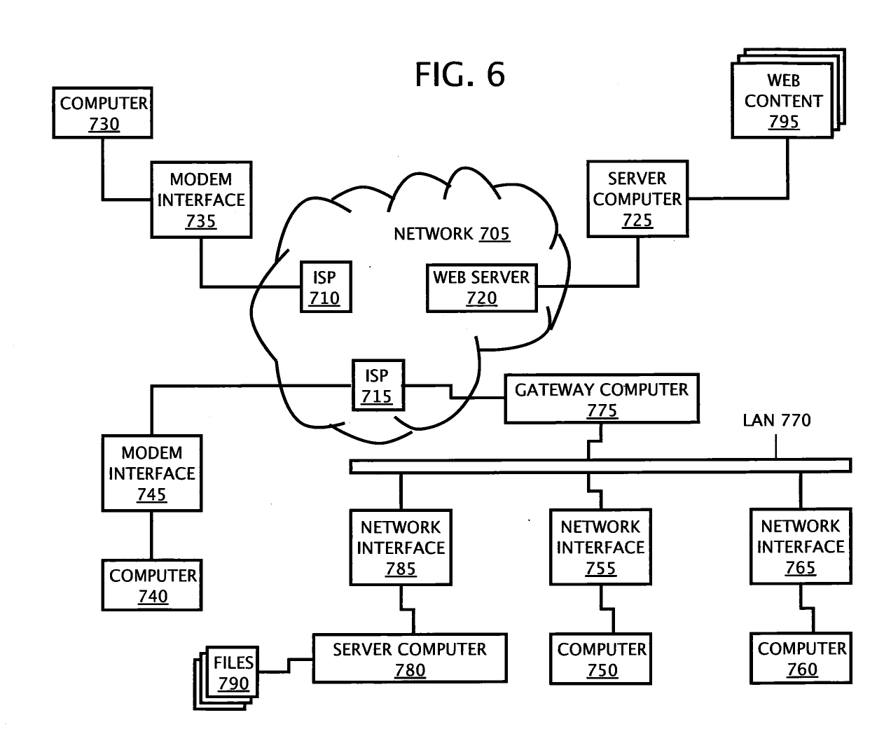

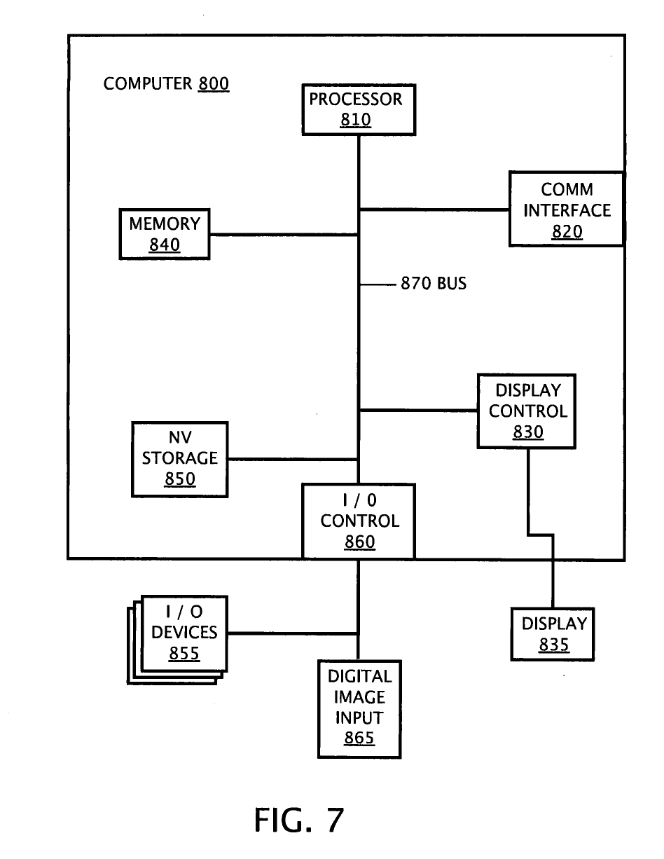

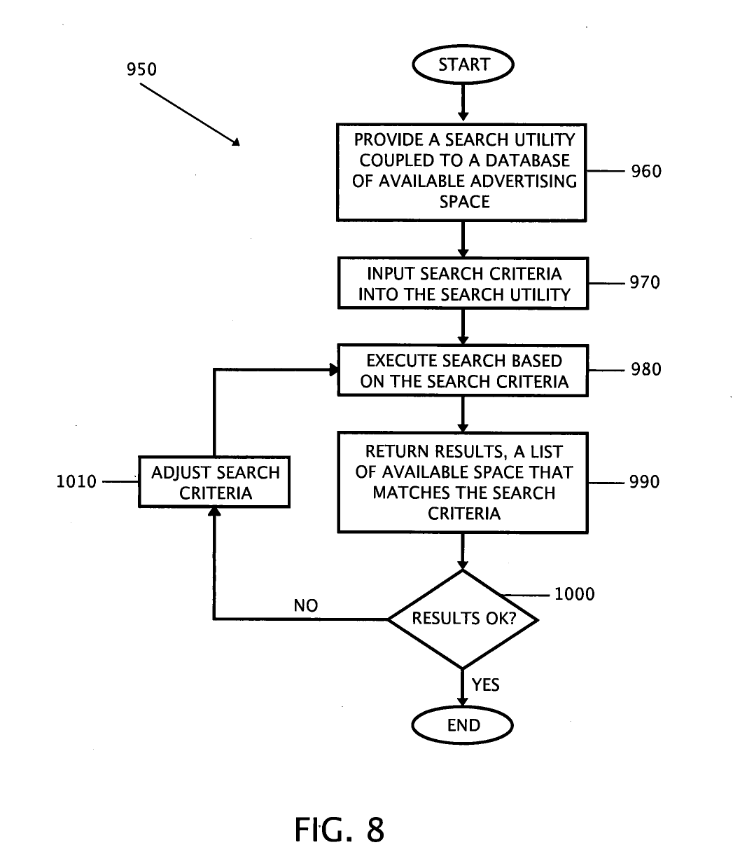

The following description of FIGS. 5-6 is intended to provide an overview of computer hardware and other operating components suitable for performing the methods of the invention described above, but is not intended to limit the applicable environments. Similarly, the computer hardware and other operating components may be suitable as part of the apparatuses of the invention described above. The invention can be practiced with other computer system configurations, including hand-held devices, multiprocessor systems, microprocessor-based or programmable consumer electronics, network PCs, minicomputers, mainframe computers, and digital audio receivers that may receive digital radio broadcasts from a satellite and the like. The invention can also be practiced in distributed computing environments where tasks are performed by remote processing devices that are linked through a communications network.

FIG. 5 is a block diagram of an exemplary embodiment of a network 705, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art.

Access to the Internet 705 is typically provided by Internet service providers (ISP), such as the ISPs 710 and 715. Users on client systems, such as client computer systems 730, 740, 750, and 760 obtain access to the Internet through the Internet service providers, such as ISPs 710 and 715. Access to the Internet allows users of the client computer systems to exchange information, receive and send e-mails, and view documents, such as documents which have been prepared in the HTML format. These documents are often provided by web servers, such as web server 720 which is considered to be “on” the Internet. Often these web servers are provided by the ISPs, such as ISP 710, although a computer system can be set up and connected to the Internet without that system also being an ISP.

The web server 720 is typically at least one computer system which operates as a server computer system and is configured to operate with the protocols of the World Wide Web and is coupled to the Internet. Optionally, the web server 720 can be part of an ISP which provides access to the Internet for client systems. The web server 720 is shown coupled to the server computer system 725 which itself is coupled to web content 795, which can be considered a form of a media database. While two computer systems 720 and 725 are shown in FIG. 5, the web server system 720 and the server computer system 725 can be one computer system having different software components providing the web server functionality and the server functionality provided by the server computer system 725 which will be described further below.

Client computer systems 730, 740, 750, and 760 can each, with the appropriate web browsing software, view HTML pages provided by the web server 720. The ISP 710 provides Internet connectivity to the client computer system 730 through the modem interface 735 which can be considered part of the client computer system 730. The client computer system can be a personal computer system, a network computer, a Web TV system, or other such computer system.

Similarly, the ISP 715 provides Internet connectivity for client systems 740, 750, and 760, although as shown in FIG. 5, the connections are not the same for these three computer systems. Client computer system 740 is coupled through a modem interface 745 while client computer systems 750 and 760 are part of a LAN. While FIG. 5 shows the interfaces 735 and 745 as generically as a “modem,” each of these interfaces can be an analog modem, ISDN modem, cable modem, satellite transmission interface (e.g. “Direct PC”), or other interfaces for coupling a computer system to other computer systems.

Client computer systems 750 and 760 may be coupled to a LAN 770 through network interfaces 755 and 765, which can be Ethernet network or other network interfaces. The LAN 770 is also coupled to a gateway computer system 775 which can provide firewall and other Internet related services for the local area network. This gateway computer system 775 is coupled to the ISP 715 to provide Internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the Internet through the gateway system 775.

FIG. 6 is a block diagram of an exemplary embodiment of a computer that can be used as a client computer system or a server computer system or as a web server system. Such a computer system can be used to perform many of the functions of an Internet service provider, such as ISP 710. The computer system 800 interfaces to external systems through the modem or network interface 820. It will be appreciated that the modem or network interface 820 can be considered to be part of the computer system 800. This interface 820 can be an analog modem, ISDN modem, cable modem, token ring interface, satellite transmission interface (e.g. “Direct PC”), or other interfaces for coupling a computer system to other computer systems.

The computer system 800 includes a processor 810, which can be a conventional microprocessor such as an Intel Pentium microprocessor or Motorola Power PC microprocessor. Memory 840 is coupled to the processor 810 by a bus 870. Memory 840 can be dynamic random access memory (DRAM) and can also include static RAM (SRAM). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). The input/output devices 855 can include a keyboard, disk drives, printers, a scanner, and other input and output devices, including a mouse or other pointing device. The display controller 830 and the I/O controller 860 can be implemented with conventional well known technology. A digital image input device 865 can be a digital camera which is coupled to an I/O controller 860 in order to allow images from the digital camera to be input into the computer system 800.

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to this embodiment, but it may lack some of the features shown in FIG. 5, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows® from Microsoft Corporation of Redmond, Washington, and their associated file management systems. Another example of an operating system software with its associated file management system software is the LINUX operating system and its associated file management system. The file management system is typically stored in the non-volatile storage 850 and causes the processor 810 to execute the various acts required by the operating system to input and output data and to store data in memory, including storing files on the non-volatile storage 850.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. An advertising auction system comprising:
an administration server for managing available advertising space and advertising auctions;
one or more publishers that list available advertising space at the administration server;
one or advertisers that bid on the available advertising space wherein a highest bidder at a close of an auction will have their advertisement placed at the available advertising space made available by the one or more publishers for a period of time; and
a scheduling/delivery server that schedules when advertisements are to be displayed, delivers advertisements to display locations and plays the advertisements.

2. The advertising auction system as recited in claim 1 wherein the available advertising space is located on a public digital display.

3. The advertising auction system as recited in claim 1 wherein the public digital display is controlled by an advertisement player server that connects to the administration server periodically for updates.

4. The advertising auction system as recited in claim 1 wherein the available advertising space is located on a webpage.

5. The advertising auction system as recited in claim 1 wherein the available advertising space is located at a web portal such as AOL or Yahoo.

6. The advertising auction system as recited in claim 1 wherein the available advertising space is located on traditional print media.

7. The advertising auction system as recited in claim 1 wherein the available advertising space is located on television.

8. The advertising auction system as recited in claim 1 wherein the available advertising space is located on radio.

9. The advertising auction system as recited in claim 8 wherein the radio is digital/satellite radio.

10. The advertising auction system as recited in claim 8 wherein the radio is frequency modulation (FM) or amplitude modulation (AM) radio.

11. The advertising auction system as recited in claim 1 wherein a reverse auction is utilized wherein an advertiser of the one or more advertisers lists their advertisement and preferences and the one or more advertisers bid on the advertisement such that a low bidder wins the reverse auction and the advertiser pays the winning publisher an amount equal to the low bid.

12. The advertising auction system as recited in claim 1 wherein an operator of the system receives a portion of a highest bid for each completed auction.

13. The advertising auction system as recited in claim 1 wherein one or more rules of an auction is set by a publisher of the one or more publishers.

14. The advertising auction system as recited in claim 13 where the one or more rules comprises at least one of a minimum bid, a block of time for an advertisement to be displayed, a minimum duration of the advertisement and a maximum duration for the advertisement.

15. The advertising auction system as recited in claim 1 wherein an advertisement is verified for content before it is displayed on the available advertising space.

16. A method for a networked advertising auction comprising:
accepting one or more listings of available advertising space from one or more publishers, over a network;
accepting one or more bids from one or more advertisers, over the network, to utilize the available advertising space;
accepting an advertisement, over the network, from a highest bidder of the one or more advertisers;
sending the advertisement, over the network, to a publisher of the one or more publishers to be displayed on the available advertising space.
